(19) United States
(12) Patent Application Publication
(10) Pub. No.: US 2025/0061529 A1
(43) Pub. Date: Feb. 20, 2025

(54) AI-ASSISTED SUBJECT MATTER MANAGEMENT SYSTEM

(71) Applicants: Raul Saldivar, III, Dana Point, CA (US); Josephine Wall, Framingham, MA (US)

(72) Inventors: Raul Saldivar, III, Dana Point, CA (US); Josephine Wall, Framingham, MA (US)

(21) Appl. No.: 18/450,182

(22) Filed: Aug. 15, 2023

(51) Int. Cl. G06Q 50/20; G06F 40/174; G06F 40/284; G06Q 10/10

(52) U.S. Cl. CPC G06Q 50/205; G06F 40/174; G06F 40/284; G06Q 10/103

(57) ABSTRACT

System and methods herein are configured to receive and ingest a set of course materials, receive user requests from teachers or students, tokenize and generate vector embeddings based on the user requests, and compare generated input vector embeddings vector embeddings associated with workflows to find a matching workflow. The systems and methods are further configured to obtain a subset of the course materials corresponding to the matching workflow, generate a prompt, and submit the prompt to a language model. The systems and methods are further configured to provide a response to the prompt back to the user.

### FIELD

The present disclosure relates to interactive systems that leverage artificial intelligence for providing interactive knowledge bases for educational and other related purposes.

### BACKGROUND

Conventional education and training systems are unable to provide individualized and effective interactive experiences that provide customized assistance to students or other users based on contextual data including what they know, what they may be attempting to learn, their preferred learning style, the best available learning materials, and the like. Meanwhile, recent advances in language models and other artificial intelligence systems are able to provide low cost and somewhat tailored explanations of various subject matter, but these models are restricted to data that is encoded via generalized pretraining (e.g., pretraining based on public data) as well as whatever data is supplied as context to the model. Efficient and effective systems for integrating education systems with recent AI advances have not yet been designed or built.

### SUMMARY

Provided herein are systems and methods for processing requests related to course materials for an educational course or other subject matter contained within a knowledge base. The method may include receiving, by a server platform, a set of course materials or other subject matter. The method further includes ingesting, by the server platform, the set of course materials or subject matter into a vector database. The method further includes receiving, by the server platform, a request comprising a string of text from a user, wherein the user is associated with a role. In some contexts, the role may indicate the user is an instructor or a student. The method further includes tokenizing, by the server platform, the string of text using a tokenizer. The method further includes generating, by the server platform, one or more input vector embeddings for the tokenized string of text using an embeddings model. The method further includes comparing, by the server platform, the one or more input vector embeddings to at least one set of vector embeddings associated with workflows to find a matching workflow. The method further includes obtaining, by the server platform, a subset of the course materials or other subject matter corresponding to the matching workflow from the vector database. The method further includes generating, by the server platform, a prompt based on the workflow and the subset of course materials or other subject matter. The method further includes submitting, by the server platform, the prompt to a language model. The method further includes receiving, by the server platform, a response to the prompt from the language model. The method further includes providing, by the server platform, the response to a user device of the user.

In some embodiments, the comparing comprises: comparing the one or more input vector embeddings to a first set of vector embeddings to recognize an action associated with the string of text; comparing the one or more input vector embeddings to a second set of vector embeddings to recognize at least one object associated with the string of text; and selecting the matching workflow based on the recognized action and the at least one recognized object. In some of these embodiments, comparing the one or more input vector embeddings to the second set of vector embeddings comprises multiple comparison passes to recognize multiple objects associated with the string of text.

In some embodiments, the string of text from the user is generated using a speech to text algorithm that processes audio data from the user.

In some embodiments, the workflow is associated with a form, and the method further comprises: generating, by the server platform, an interactive user interface for completing the form; transmitting, by the server platform, the interactive user interface to the user; receiving, by the server platform, a completed form from the user; and storing, by the server platform, the completed form in the vector database, wherein data from the completed form may be submitted as part of a future prompt to the language model. In some of these embodiments, the interactive user interface is generated for a web interface, and the method further comprises: determining that the user is using a mobile interface on the user device; and redirecting the user to the web interface.

In some embodiments, providing the response to the user comprises: converting the response to audio using a speech to text model; and transmitting the audio to the user device.

In embodiments, the request and the response are a first request and a first response, and the method further comprises: receiving a second request comprising a second string of text from the user; tokenizing the second string of text using the tokenizer; generating one or more second input vector embeddings for the tokenized second string of text using the embeddings model; comparing the one or more second input vector embeddings to the at least one set of vector embeddings associated with workflows; determining that none of the workflows match the one or more second input vector embeddings; responsive to the determining, submitting the one or more second input vector embeddings as a second prompt to the language model; receiving a second response to the second prompt from the transformer language model; and providing the second response to the user device of the user for display together with the first request, first response, second request, and second response. In some of these embodiments, the method further comprises: storing the first request, first response, second request, and second response in the vector database; and fine-tuning the language model using a data set that includes the first request, first response, second request, and second response. In some of these embodiments, the data set further includes a plurality of requests and responses that are associated with a particular course for a particular educational institution, such that the fine-tuned language model is customized to the particular course and the particular educational institution.

In embodiments, the matching workflow comprises one or more of: a workflow that allows the instructor to generate an assignment based on a subset of the course materials; a workflow that allows the instructor to generate an assessment based on a subset of the course materials; a workflow that allows the instructor to interact with a curriculum; a workflow that allows the instructor to input data about an educational institution; a workflow that allows the instructor to input data about one or more students; a workflow that allows the student to ask for assistance with a subset of course materials; a workflow that allows the student to complete the assignment; or a workflow that allows the student to complete the assessment.

In embodiments, the method further comprises: after providing the response to the user device, requesting feedback from the user on the response; and based on the feedback, determining whether to update the course materials using the response. In some of these embodiments, the matching workflow is a workflow that allows the instructor to generate an assignment, the response comprises the generated assignment, and requesting feedback comprises requesting whether the generated assignment should be saved and assigned to students. In some of these embodiments, the method further comprises, responsive to receiving feedback indicating that the generated assignment should be saved and assigned to students, transmitting a notification to the students that the assignment is available. In some of these embodiments, the method further comprises: determining that at least one of the students has completed the assignment; and transmitting a notification to the instructor indicating that at least one of the students has completed the assignment.

In some embodiments, the comparing comprises generating a similarity score using a dot product operation. Additionally or alternatively, the method further comprises: prior to providing the response to a user device of the user, modifying the response to include a question about the user; receiving an answer from the user to the question about the user; and storing the answer from the user in the vector database, wherein the answer from the user may be submitted as part of a future prompt to the language model. Additionally or alternatively, the course materials include a textbook.

A more complete understanding of the disclosure will be appreciated from the description and accompanying drawings and the claims, which follow.

### BRIEF DESCRIPTION OF THE DRAWINGS

The accompanying drawings, which are included to provide a better understanding of the disclosure, illustrate embodiment(s) of the disclosure and together with the description serve to explain the principle of the disclosure. In the drawings:

FIG. 1 illustrates an example environment according to some embodiments of the present disclosure.

FIG. 2 illustrates example data within a database according to some embodiments of the present disclosure.

FIG. 3 illustrates an example flowchart comprising operations performed according to some embodiments of the present disclosure.

FIG. 4 illustrates an example sequence diagram comprising operations performed according to some embodiments of the present disclosure.

FIG. 5 illustrates an example flowchart comprising operations performed according to some embodiments of the present disclosure.

FIG. 6 illustrates an example method comprising operations performed according to some embodiments of the present disclosure.

### DETAILED DESCRIPTION

Techniques described herein enable the integration of language models and other recent artificial intelligence (AI) advances with traditional educational materials, such as textbooks or other materials, to provide several benefits. For example, the techniques described herein leverage the personalization capabilities of language models to enable a system that can analyze a student's past interactions, performance, and/or learning style to create a personalized learning resource. The system can adapt the content, pace, and style of learning based on individual students' needs. The system therefore enables more effective learning because the content may be specifically tailored to a learner's level of understanding, interest, and learning style.

The techniques described herein are also useful outside of traditional educational contexts. For example, instead of or in addition to textbooks or other course materials, the techniques described herein may leverage training materials, legal materials, corporate knowledge bases, or other subject matter to provide education and training in corporate contexts, legal contexts, healthcare contexts, or any other context in which education or training may be desirable. It should be understood that although some of the examples described herein use a more traditional educational context (e.g., with one or more teacher and student users), the techniques and systems described herein are useful in any educational or training contexts and with various types of subject matter.

Additionally, techniques described herein provide a system that can quickly and efficiently sift through large amounts of educational content (e.g., huge volumes of textbooks, including many different textbooks that may cover the same topic, large corporate knowledge bases, various pay-walled databases, etc.) to filter out the most relevant learning materials for each user (e.g., student, employee, subscriber, customer, etc.). Accordingly, the system described herein can save both users (e.g., students) and administrators (e.g., teachers) significant time and effort on educational course design and study/learning.

Moreover, the system described herein enables a more interactive and adaptive learning process that users may find to be more engaging. For example, the system can assist in generating interactive assignments or other assessments and can facilitate real-time interactions, feedback, and corrections, thereby making the learning experience more dynamic.

Furthermore, techniques described herein increase the scalability of education and training. For example, the system described herein enables teachers or other administrators to manage and deliver personalized content to a large number of users/students simultaneously, which can be especially beneficial in large classes or online learning scenarios, large corporate contexts, etc.

The system described herein enables a seamless integration of various types of educational materials like textbooks with other course materials, including digital content, thereby providing a comprehensive learning experience. The system can also facilitate the inclusion of multimedia materials, such as videos, images, and interactive modules, into the learning workflow.

The system described herein can continuously assess each user's progress and adapt each user's training/learning accordingly. The system can provide quicker feedback, highlight areas of weakness, and suggest targeted exercises to improve those areas.

Moreover, in teacher-supported contexts, the system described herein not only aids students but also supports teachers. It can automate certain routine tasks as part of grading and assignment creation, freeing up teachers to focus on more complex tasks like lesson planning and student guidance.

Moreover, the system provides accessible interface(s) with the ability to present information in various formats (e.g., text, audio, visual), thereby making learning more accessible for users with diverse learning needs or disabilities.

Furthermore, the system can learn and adapt over time, improving its recommendations and personalization as it gathers more data on user performance and preferences.

These and other benefits are described in more detail below.

### Environment

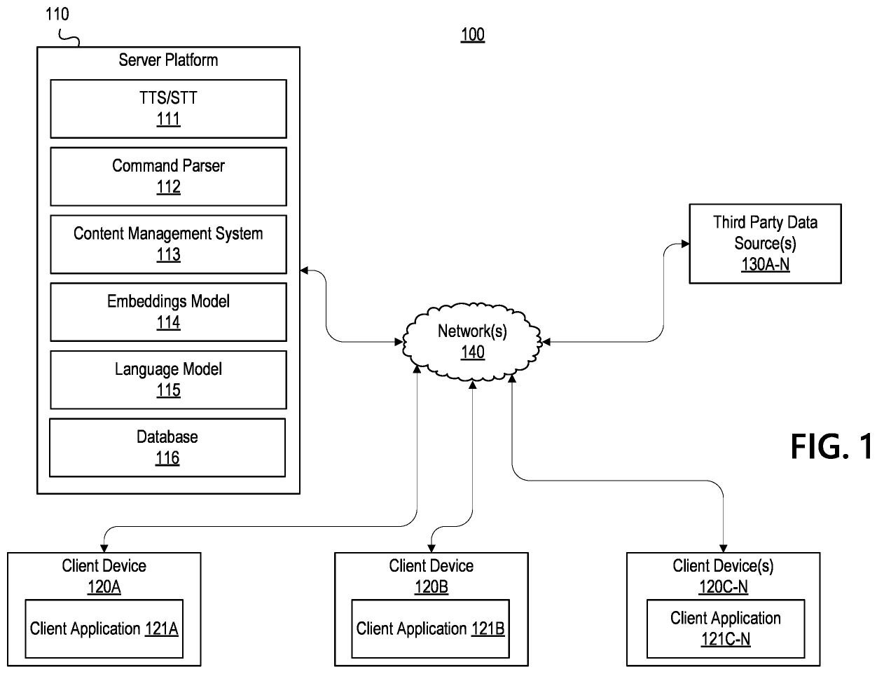

FIG. 1 shows an environment 100 including components that carry out methods and operations as described in more detail below. The environment 100 may include a plurality of devices that comprise a server platform 110, various client devices 120A-N, and one or more third party data sources 130A-N, where the plurality of devices are connected via one or more network(s) 140. The network connections shown are illustrative and any means of establishing communications links between the various devices may be used. The existence of any of various network protocols such as TCP/IP, Ethernet, FTP, HTTP and the like, and of various wireless communication technologies such as GSM, CDMA, Wi-Fi, and LTE, is presumed, and the various computing devices described herein may be configured to communicate using any of these network protocols or technologies.

The server platform 110 may itself include a plurality of devices or components, including one or more platform text-to-speech and/or speech-to-text (herein STT/TTS) modules 111, a command parser 112, a content management system 113, an embeddings model 114, a language model 115, and a database 116. In general, the platform 110 may provide functionality to the various client devices 120 that allows users of the devices to execute various educational workflows and perform various other actions as explained in more detail below. For example, the TTS/STT module 111 may be configured to perform various speech-to-text and text-to-speech operations for user requests and responses in service of the various methods and flows described herein. The command parser 112 may be configured to parse user requests and the map the user requests to workflows that may be executed by the server platform 110 as described in more detail below. The content management system 113 may be configured to retrieve relevant content from a database 116 in service of various workflows as described in more detail below. The embeddings model(s) 114 and language model(s) 115 may be machine learning models or algorithms that are configured to generate embeddings and responses to prompts generated by the various workflows, respectively, as described in more detail below. Third party data sources 130A-N may include any sources of various data (e.g., course data) that may be ingested by and used by the platform, as described more below.

In embodiments, the various data ingested by the platform 110 (e.g., data from third party data sources 130A-N and/or any other data stored by the platform 110) may be categorized and/or have other metadata generated or added to the database 116. For example, when a textbook is loaded into the database 116, the platform 110 may store the data in a hierarchical format within categories and/or sub-categories. For example, a first subsection of a first chapter may be stored in a first category and first sub-category, a second subsection of the first chapter may be stored in a first category and second sub-category, and so on. Other metadata in various formats may also be generated and used by the platform 110. In embodiments, as described in more detail below, the metadata may allow users to inquire about certain types of data, ask what concepts certain data relates to, and/or the like.

The client devices 120 may be user devices used by various users (e.g., students, teachers, administrators) to interact with the platform via a client/browser application 121 on each device. For example, one user may use a device 120A in an administrator role to configure an organization's data, another user may use another device 120B in a teacher role to configure a course, create assignments and assessments, etc., and a third user may use another device 120C in a student role to learn various materials, complete course assignments and assessments, etc. The client devices 120 may include mobile devices (e.g., smartphones, laptops, tablets), wearable devices (e.g., smartwatches, VR/AR/XR headsets), other computing devices (e.g., desktop computers, servers), and/or any other devices that may run and interact with the client application 121. In embodiments, the client application 121 may communicate with the server platform 110, which may provide a client/server user interface that allows respective users of the devices 120 to interact with the platform 110. Additionally or alternatively, the client application 121 may perform any of the features and functionalities ascribed to the platform 110, such that the system may be completely decentralized, partially decentralized, and/or perform any of the operations described herein locally on the devices 120. In embodiments, the client application 121 may be one of various web browsers, which may be used interchangeably. For example, a first device 120A may use a CHROME web browser 121A, another device 120B may use an EDGE web browser 121B, etc., where each device may use any web browser. Additionally or alternatively, the client application 121 may include various applications that may be native to various operating systems, such as a WINDOWS client application, an OSX client application, etc.

In embodiments, the platform 110 may include one or more computing devices that may implement one or more respective servers, databases, etc. In embodiments, the platform 110 may be implemented using a cloud services provider, which may manage the distribution of tasks and/or workloads across the various computing devices. The computing device(s) making up the platform 110 may execute the methods and operations described herein using serial, parallel, hierarchical, and/or other computing techniques. For example, a first computing device may distribute sub-tasks of a task to various computing devices of the platform (e.g., when the sub-tasks are parallelizable), may balance workloads between the computing devices, and the like. Thus, although the platform may be described as a single entity, the platform may use a plurality of computing devices working in coordination to complete the tasks described herein.

The database 116 may be implemented via various cloud services, via database servers, and/or the like. The database 116 may include, but is not limited to, one or more relational databases, hierarchical databases, distributed databases, in-memory databases, flat file databases, XML databases, SQL databases, NoSQL databases, graph databases, and/or a combination thereof.

The embeddings model(s) 114 and/or language model(s) 115 may include various types of models that may be run locally by the server platform 110 and/or via remote servers. For example, the language model 115 may include a transformer-based model (e.g., a large language model) or other machine-learning model or other algorithms for generating responses to user requests. Similarly, the embeddings models 114 may be transformer-based models, algorithms such as Word2Vec or Fasttext, or any other embedding model/algorithm. Example models may be provided by Hugging Face or other organizations. It is possible that the embeddings model 114 and the language model 115 are a single model. In some cases, language models 115 may be multi-modal models that may be capable of receiving inputs and/or generating outputs that include textual as well as other data, such as audio data, image data, video data, and/or the like. Furthermore, although the example methods described herein use a language model to generate responses to user requests, it should be understood that the methods described herein could be adapted to work with other generative models, such as image generation models, audio generation models, video generation models, and/or the like, without departing from the scope of the disclosure.

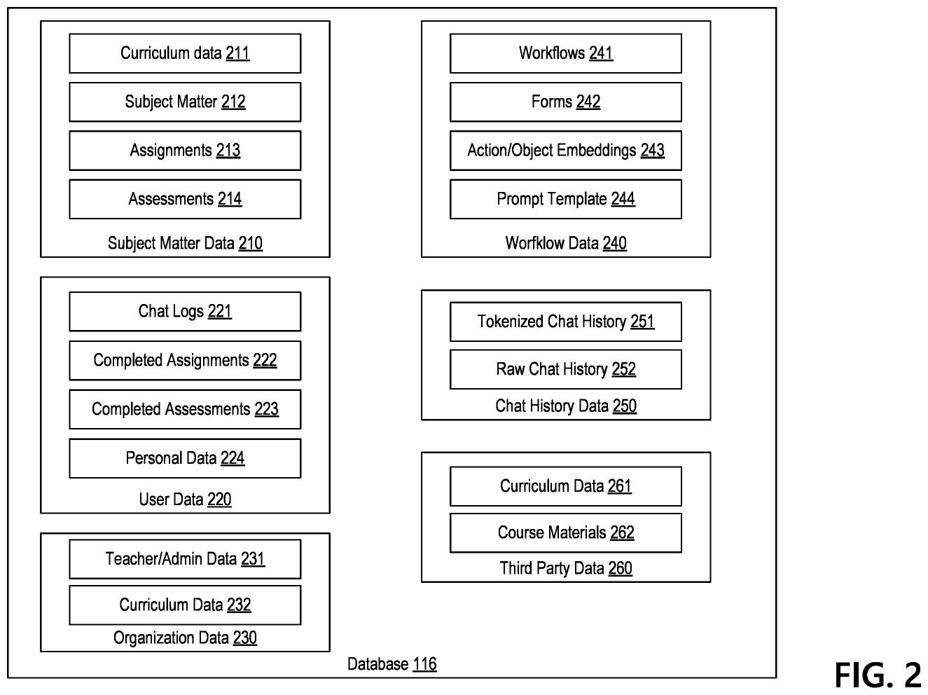

FIG. 2 illustrates additional details including various data stored in the database 116. As shown in FIG. 1B, the database 116 includes various data including subject matter data 210, user data 220, organization data 230, workflow data 240, chat history data 250, and/or third-party data 260, among other types of data (not illustrated) that may be used to implement the methods described below. Various functions and attributes of the data will be described in more detail below. Briefly, the subject matter data 210 may include curriculum data 211 (e.g., course syllabi, grading schemes, due dates, and/or other curriculum data), subject matter 212 (e.g., various educational resources in different formats, such as electronic textbooks, videos, interactive learning materials, software for completing assignments or assessments, etc.), assignments 213 (e.g., question and/or answer data, due dates, etc.), assessments 214 (e.g., exams, quizzes, etc.), and the like. The user data 220 may include chat logs 221 (e.g., prior requests submitted by the student/user and responses thereto provided by the system), completed assignments 222 and/or assessments 223 (e.g., the answers provided by the student/user, the date submitted, a score provided automatically or by a teacher/admin, etc.), and personal data 224 (e.g., identification information, learning-related information such as preferred learning styles, and/or any other user-specific data that may be leveraged by the system), and the like. The organization data 230 may include teacher/admin data 231 for various teachers or other administrator users (e.g., teacher's teaching preferences, course templates or materials, etc.), curriculum data 232 (e.g., default or optional course listings, graduation or course completion requirements, etc.), and the like. The workflow data 240 may include various workflows 241 (e.g., templates or instructions for responding to certain types of requests, as described in more detail below), forms 242 (e.g., interactive forms that may be provided to a user as part of executing a workflow so that the user provide direct input in a structured format), action/object embeddings 243 (e.g., various prestored vector embeddings that may be used to match a user request to a workflow, as described in more detail below), prompts 244 (e.g., instructions or templates for generating a prompt for a language model as part of executing a workflow, as described in more detail below), and the like. The chat history data 250 may include chat logs or other conversation histories stored in various formats, including a tokenized chat history 251 and/or a raw chat history 252. In embodiments, a raw chat history 252 may include text data and/or other media data (e.g., images, audio, video, interactive data, code, etc.) that may be provided by a user and/or generated by a language model (e.g., if the language model is multi-modal). The third-party data 260 may include curriculum data 261, course materials 262, and the like that are provided by third parties for use by the system. In some cases, the third-party data may be stored separately due to licensing or use restrictions.

### Example Methods

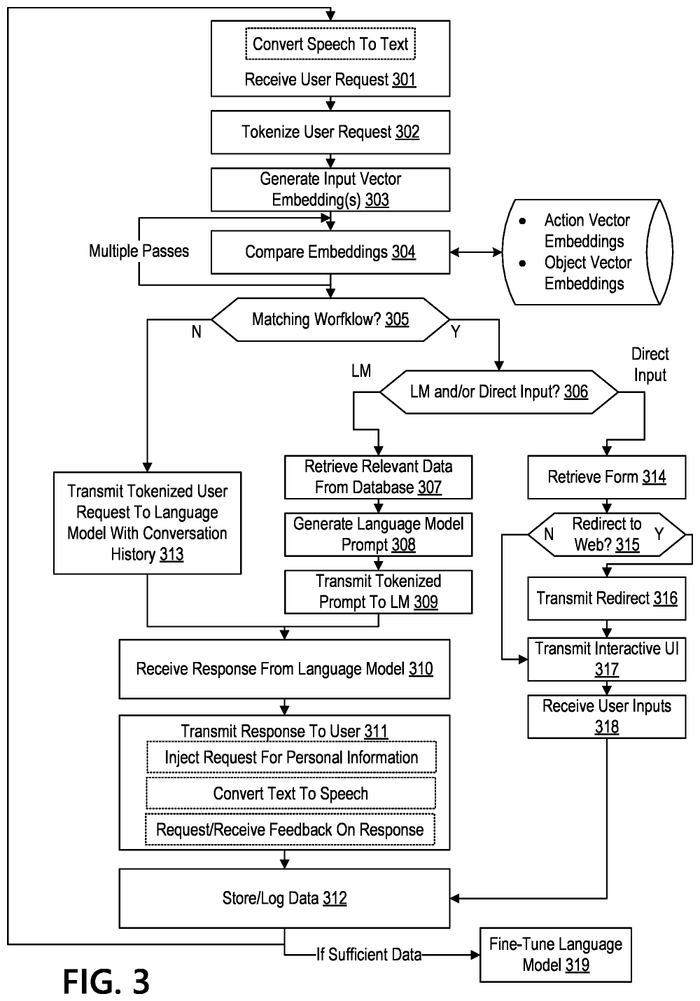

FIG. 3 illustrates a flowchart showing an example flow for executing some of the features of the system described herein. In the example of FIG. 3, the system executes a looping flow that starts with the server platform 110 receiving a user request at 301. As shown in the figure and described below, the server platform 110 may then process the request to determine one or more matching workflows (or that there is no matching workflow) and make various decisions based on the workflow. It should be noted that the flow of FIG. 3 may occur after the system has already been set up (e.g., one or more users/teachers/administrators has configured a course, course materials or other subject matter, created accounts for users/students, and/or the like), such that the system is ready to receive user requests. The flowchart of FIG. 3 is not intended to be a comprehensive flowchart illustrating each and every function of the system, but instead illustrates example operations that may be performed in at least some cases in order to explain various functionalities of the system.

At 301, the server platform may initially receive a user request. The user request may be received from various types of users such as a teacher, a student, or any other individual associated with an organization (e.g., an educational organization, a corporation, etc.). In embodiments, the request may be tagged with data indicating the user (e.g., a user ID) and/or the type of user. The user request may include user-generated content that may vary depending on what the user is seeking. For instance, the user request may include a question about course materials or other subject matter, curriculum, a request for assistance in understanding a particular topic, or any other type of request for interacting with the system. In embodiments, as described more below, the user request may involve an instruction to configure certain data. For example, a teacher or admin may request assistance with the creation of a new assignment or a new assessment for students or other users. The request may also pertain to configuring other types of data including organization data, settings data, course data, student data, chat history data, or any other data stored in the database.

In embodiments, the server platform may receive the user request as audio data, for example when a user is interfacing with the server platform using an audio interface. In these embodiments, the server platform may direct the request to a speech-to-text (STT) component for conversion of the audio data into a text format for subsequent processing.

Alternatively, the user request may be in a text format, for example when a user inputs text via a client application or web browser on a client device. Regardless of the original format, the server platform receives the user request and may optionally convert it into text. Consequently, the server platform may obtain a text-based user request that the server platform may use for further processing.

At step 302, the server platform (e.g., the command parser module) may execute a tokenization process on the text-based user request. The tokenization process involves breaking down the user request into discrete, identifiable units or ‘tokens.’ These tokens represent meaningful elements within the user request, such as parts of words, whole words, or phrases. The server platform may execute the tokenization process using various tokenization algorithms. The server platform may employ a word-level tokenization algorithm (e.g., the algorithm treats each unique word as a separate token). For example, if the user request is “Create new assignment for Algebra,” the tokenization process may produce four tokens: “Create”, “new”, “assignment”, and “Algebra”. Alternatively, the server platform may use a sub-word tokenization algorithm, which breaks down the user request into sub-word units. This tokenization method may show improved performance at dealing with compound words, misspelled words, or words not in a tokenization vocabulary. For instance, the phrase “Create new assignmment” (where “assignmment” is a typographical error) may be broken down into sub-word units, such as “assign”, “mm”, and “ent”.

Via the tokenization process, the server platform generates a tokenized user request. This tokenized user request may serve as an intermediate representation of the original user request, now segmented into individual tokens. The tokenization algorithm may associate each token with specific data, such as its position in the original request, its frequency within the request, and other relevant attributes. By including such data, the server platform may leverage the tokenization process to facilitate further processing and analysis of the user request, such as determining the intention behind the request, identifying key elements of the request, etc. In other words, the tokenized user request provides a structured format that allows for more precise and efficient handling of the request by subsequent modules or components of the server platform.

At step 303, the server platform may use the tokenized user request to generate one or more input vector embeddings. These vector embeddings can then be used for comparison with a library of pre-stored vector embeddings that are associated with workflows, as described below.

The server platform 110 may employ an embeddings model to generate the input vector embedding(s) from the tokenized user request. The embeddings model may be run locally on the server platform, or alternatively, the server platform may send the tokenized user request to an API connected to a remote server that runs an embeddings model. The choice between local and remote-based execution can depend on various factors, such as computational resources, latency requirements, or data privacy concerns. Example embeddings models are provided by Hugging Face and/or other organizations.

As described herein, a vector embedding is a vector of values corresponding to a token, wherein the vector may include a separate value for each of the number of dimensions in the embedding space. For example, if an embeddings model uses a 1000-dimensional embedding space, each token may include a vector including 1000 values, with one value per dimension.

In some embodiments, the server platform 110 may use a transformer-based embeddings model. This type of model may be a deep learning model that uses self-attention mechanisms to generate vector embeddings. Transformer-based embeddings models may be effective in capturing contextual nuances of language based on word position and other factors via the self-attention mechanisms of the transformer model. For example, if the user request is “Create a new assignment for Algebra,” a transformer-based embeddings model might generate a unique vector representation for each token (“Create,” “new,” “assignment.” “Algebra”). The vector representations may capture the individual meanings of these words as well as their contextual relationships within the user request. Additionally or alternatively, the transformer-based embeddings model may generate a single vector embedding for the entire user request (e.g., if the user request includes only a single word or phrase that matches a token).

In embodiments, the server platform is not restricted to transformer-based embeddings models. Other embeddings methods, such as Word2Vec or FastText, may also be employed. Word2Vec, for instance, is a shallow neural network model that can generate word embeddings by learning from the co-occurrence of words within a certain window in the text. FastText extends the Word2Vec methodology by considering subword information, which may increase its effectiveness at handling out-of-vocabulary words and misspellings.

Regardless of the specific embeddings model used, the server platform 110 may convert each token of the user request from the tokenized user request into a corresponding vector in a high-dimensional space. These vectors may be referred to herein as input vector embeddings. The input vector embeddings may capture the individual and/or contextual meanings of each token in the user request. As described below, the generated input vector embeddings facilitate the subsequent comparison of the user request with a library of pre-stored vector embeddings in the same embeddings space.

At step 304, the server platform may compare the input vector embeddings generated in the previous step to each of one or more pre-stored embeddings associated with different workflows. These pre-stored embeddings could be of different types, for instance, action vector embeddings associated with specific actions, and object vector embeddings associated with certain objects. By combining one or more action vector embeddings with one or more object vector embeddings, the server platform may be capable of selecting a matching workflow, composed of an action and one or more objects. It should be noted that a matching workflow may not be a “perfect” match (e.g., the matching may be probabilistic or “fuzzy” matching) because the system may use similarity metrics as described below to find a most similar workflow based on the input vector embeddings. As described below, the server may then execute any matching (e.g., most similar) workflow.

Thus, at step 304 the server platform may compare the input vector embeddings to the pre-stored vector embeddings from a database using a command parser to perform one or multiple comparison passes. The command parser may use various similarity metrics, such as dot product similarity, to determine which action vector embeddings and/or object vector embeddings have the highest similarity to the generated input vector embeddings. In these embodiments, the server platform may generate a dot product for use as a similarity score by multiplying the input vector embedding(s) by each prestored embedding.

For example, the user request may be to “create a new assignment for Algebra.” The server platform 110 may store one or more action vector embeddings corresponding to words such as “create.” “generate,” or similar words. Using dot product similarity, the command parser may determine that these pre-stored action vector embeddings are highly similar to one or more of the input vector embeddings (e.g., because the input word “create” is contextually very similar to “create” and/or “generate” in the embeddings space). In this example, the server platform may use a first pass to discover the highest matches among action vector embeddings. Further passes, such as second, third, fourth, and so on, may be employed to discover matches of various object vector embeddings.

Continuing with the above example, if the extracted action from the request is “create,” then in subsequent passes the command parser may compare the input vector embeddings to prestored object embeddings that may be similar to the embeddings for “assignment” and “Algebra.” The command parser may generate similarity scores (e.g., using dot product similarity) to find that the generated input vector embedding(s) are highly similar to one or more pre-stored object vector embeddings for words like “assignment,” “homework,” etc. on a second pass. Furthermore, the command parser may determine that pre-stored object vector embeddings for words like “Algebra” or “math” have high similarity to the input embedding(s) on a third pass.

While the previous example described using multiple passes, where each pass identifies a single action or object vector, the server platform may alternately perform all comparison operations in a single pass. Additionally or alternatively, the first pass may identify a single action, and a subsequent pass may identify multiple objects.

In some cases, the server platform 110 may also store negative embedding examples in addition to the positive embeddings described above. For example, if a user request indicates “don't tell me about X,” the phrase “don't tell me” may be matched to a negative action embedding. When the platform 110 detects a match to a negative embedding, it may penalize any similarity score for a positive embedding (e.g., if the platform 110 would otherwise detect a high similarity of an input embedding for “don't tell me about” to an action embedding for “tell me about,” then the high similarity score may be lowered due to the corresponding match of the negative example embedding).

In some embodiments, the server platform 110 may permission or restrict access to certain pre-stored action or object vector embeddings (or their corresponding workflows) based on user role. For example, vector embeddings for a request such as “create an assignment” may be restricted such that only requests from a teacher role can match that set of action and object vector embeddings. Other action and object vector embeddings can be restricted to student roles, administrator roles, or other roles. In this way, the server platform may limit access to specific workflows by permissioning the set of vector embeddings that can be compared to the input vector and/or the matching workflows.

It should be noted that in many cases, the server platform may not find any matching pre-stored action vector embeddings and/or object vector embeddings. In other words, the similarity score from the comparison may not rise above a certain threshold score, in which case there may not be any matching workflow.

At step 305, the server platform may determine that a particular workflow is a matching workflow (or that there is no matching workflow) based on the comparisons of the input vector embeddings to the pre-stored action and/or object vector embeddings (which may be achieved in one or multiple passes, as previously described). In some cases, the server platform 110 may use a decision tree to perform the matching. For example, the workflows 241 may correspond to nodes of the decision tree, which the platform 110 may traverse based on the matching action and/or object vector embeddings to find a matching workflow. However, other such search and/or matching algorithms may be used. The server platform may select one or more matching workflows based on a similarity score for an action and/or object that corresponds to each matching workflow being above a threshold for each corresponding node of the decision tree. In these embodiments, each workflow may be associated with one or more action embeddings and/or one or more object embeddings.

For instance, if the input vector embeddings contain the word “create,” one node of a decision tree may test whether the request has a first threshold similarity score for action vector embedding(s) for the words “create,” “generate” or similar to traverse to a first lower node. Traversing to a lower node may effectively eliminate a subset of non-matching workflows associated with other workflows, where each traversal of the decision tree narrows the search space. Subsequent nodes below the first lower node of the tree may be associated with different object vector embeddings, which may be traversed to find a matching workflow in a similar manner. In these embodiments, workflows may be leaves of the decision tree that may be matched if all the nodes are matched.

As another example, a workflow may be associated with action vector embeddings for the word “create” or “generate,” one or more first object vector embeddings for the words “homework” or “assignment,” and one or more second object vector embedding that specify any type of content. Such a workflow may be three nodes deep in a decision tree, where a first node (after the root node) is associated with the action vector embeddings, a second node with the first object vector embeddings, and a third node with the second object vector embeddings. Therefore, after receiving an input vector embedding corresponding to a request of “create an assignment for algebra,” the server platform 110 may find a high similarity between the input vector embeddings and the action vector embeddings for the workflow at a first node, a high similarity between the input vector embeddings and the first object vector embeddings at a second node, and a high similarity score between the input vector embeddings and the second object vector embeddings at a third node. Based on these determinations, the server platform 110 may detect a matching workflow.

Thus, the command parser may use flexible methods for workflow matching. In certain cases, workflows may match specific action vector embeddings like “create,” “generate,” or specific object vector embeddings like “homework,” or “assignment.” Additionally or alternatively, workflows may match vector embeddings for types of content, such as any vector embedding that specifies a type of course material or course, such as “algebra.” In embodiments, the server platform may use a lower threshold to detect a match to an embedding for a type of content.

The server platform may maintain a variety of workflows in the database, each potentially associated with different actions and varying numbers of objects. For example, the system may store a first workflow for creating an assignment or assessment of a specified type and a second workflow for creating an assignment or assessment where no further specification is given. The workflows may be configured to retrieve additional content as needed (e.g., the content specified content in the request, an inferred type of content based on other factors, etc.), as described below.

The server platform 110 may store additional example workflows for various contexts, such as educational workflows for creating an assessment, for requesting information about certain course materials, for configuring organization data, for asking questions about students enrolled in a course, for configuring a curriculum, for requesting guidance before completing an assignment, for requesting instructions for using course-related software, etc. Similar workflows may be provided for other training contexts (e.g., corporate training, legal research, training/assessment of healthcare workers, etc.), such as workflows for creating assessments, learning material from a knowledge base, configuring user access to various data, etc. Each workflow may be associated with various actions (e.g., embeddings for various action phrases such as “help me learn” or “please teach me about”) and various objects (e.g., specific objects or types of objects). Because the embeddings models are designed to handle contextual similarity using the high-dimensional embeddings space, each workflow does not need to be stored with a comprehensive set of action and/or object embeddings to find a match. Instead, as long as the user request is contextually similar to the prestored actions and/or object embeddings, the server platform 110 may generate a high similarity score using the dot product comparison of the input vector embeddings to the prestored vector embeddings.

Example workflows in may include a workflow that allows an instructor or administrator to generate an assignment based on a subset of course materials or subject matter, a workflow that allows an administrator or instructor to generate an assessment based on a subset of course materials or other subject matter, a workflow that allows an administrator or instructor to interact with a curriculum, a workflow that allows an administrator or instructor to input data about an educational institution or other organization, a workflow that allows an administrator or instructor to input data about one or more students or other end users, a workflow that allows a student or other end user to ask for assistance with a subset of course materials or other subject matter, a workflow that allows a student or other end user to complete an assignment, and a workflow that allows a student or other end user to complete an assessment. However, these are only example workflows. For example, other workflows may allow users to ask different types of questions about course material or other subject matter, such as specific questions pertaining to groupings of course material or other subject matter (e.g., “What is chapter 5.3 about?”). Each of these workflows may be handled using the methods described herein, either with direct input and/or by providing relevant data (e.g., course materials, associated metadata stored in the database, and/or any other data stored in the database) as part of a prompt to a language model.

In educational embodiments, certain workflows are specifically designated for teachers or students. Teacher workflows might include actions like “retrieve a curriculum” for a specified class or “update a curriculum” to cover a specified type of new material. On the other hand, student workflows might involve actions like “teach me about” a specified material or “please get my chat history” about a certain topic. Additionally or alternatively, workflows may be designated for other types of users (e.g., admin users, end users such as employees or customers with varying levels of data access, etc.). In embodiments, data within the database may be access-restricted to certain users or types of users.

In embodiments, workflows may be associated with a type (e.g., assessment, announcement, discussion, etc.). Certain types of workflows may have attributes or instructions associated with them. For example, a workflow with an “assessment” type may have attributes/instructions indicating which type of questions should be included for the assessment (e.g., multiple choice, etc.), the type of assessment (e.g., pop quiz, test), and/or the like. Each attribute and/or instruction may be associated with a different prompt that may be supplied to the language model, different forms for direct input, etc.

In instances where there is no matching workflow (e.g., because none of the action and/or object vector embeddings have a particularly high similarity score, such as a score that rises above a similarity score threshold), there may be no workflow that matches. Alternatively, the system may include a default or catch-all workflow that is selected when no other workflows match.

At decision 306, the server platform may determine, based on the matching workflow, whether a prompt should be submitted to a language model or whether additional information should be obtained from the user via direct input methods. The matching workflow may be associated with either a language model prompt, a direct input, or both.

For example, a workflow where a student or other user requests assistance in learning about subject matter may specify the use of a language model. In this example, the language model may be capable of providing tailored assistance to the student/user based on the course materials or other subject matter that may be provided to the language model as part of a prompt. The student/user may then interact with the prompted language model, which may explain the material to the student/user and answer questions about the materials.

Direct input methods may be more appropriate when a workflow requires the user to input discrete data in a specified format. Direct input methods may leverage drop-down menus, input forms, or other interactive user interfaces that may helpfully constrain the user input or make it easier for a user to input information in a structured format. For example, a workflow where a teacher or other admin wishes to configure a curriculum may specific several direct inputs that may allow the teacher/admin to select information such as the number of assignments that a course will include, due dates for assessments, the number of assessments, how much grading weight is assigned to each assessment, and other such information. This data may be input by the teacher/admin into a form that is generated by the server platform.

In some examples, such as a workflow for generating an assignment, the workflow may specify both language model prompts and direct input. For example, a teacher may input questions and correct answers via direct input, and the language model may then assist in generating scoring criteria for answering the questions, generating incorrect answers for multiple-choice questions, finding or summarizing reference sections of course materials that may be useful for answering the question, or other tasks that may be relevant to assisting in generating an assignment.

Accordingly, a workflow may be associated with a language model, with direct input, or with both. Depending on the workflow, the server platform 110 may proceed along different paths as shown in the figure, which may include a language model path, a direct input path, and/or both in parallel or in series. In some embodiments, the workflow may specify an order of operations that is different than the one illustrated. For instance, a workflow may indicate that the server platform should obtain certain direct input elements, then the server platform should generate a prompt for sending to a language model, then the server platform should use the prompt response to generate additional elements for direct input. In this way, the workflow may dictate whether a language model path or a direct input path is performed first, in parallel, or whether different steps from the different paths are performed in different orders or in various other ways. Therefore, the paths shown in the figure are only exemplary, and the steps described can be performed in any order as specified by any workflow.

At step 307, in embodiments in which the workflow is associated with a language model, the content management system of the server platform may retrieve pertinent data from the database for provision to the language model. This data may provide helpful context to the language model, which may be useful for understanding and responding to a user's request or some other prompt.

As an example, a user may request assistance in understanding particular subject matter. Using a matching workflow, the content management system may locate the relevant material in the database and provide it to the language model along with a request for an explanation or other assistance. The material in the database may be stored in a vectorized format, allowing for the content management system to find and retrieve the information using a vector-based comparison. For example, if the user's request is “Please teach me about the distributive property of multiplication,” the corresponding workflow may involve an action-object such as “teach me” or “help me.” and the object specifies the type of material that the user wishes to understand better. In this case, the server platform may use the input vector embedding(s) for the specified type of material (e.g., the distributive property of multiplication) as a query to the vector database. Thus, the server platform may leverage one or more of the input vector embeddings to extract relevant data from the database using a vector comparison.

For additional explanation, a vector database may allow the server platform to directly compare embeddings in a user request to the vectorized version of content in a database. This comparison results in the server platform finding and selecting the appropriate content from the vector database and retrieving it. For example, the server platform may compare the query to the database to detect a set of materials associated with the distributive property of multiplication using similarity scores as described above.

The vectorized database may store each piece of content along with a vector representation, which is (as described above) a mathematical construct that captures its semantic properties as embeddings. The server platform 110 may then directly compare vectorized object from the request to the vector stored in the database. Thus, the content in the database and the user's object request are in the same mathematical (embeddings) space, allowing for direct comparison (e.g., using dot product, cosine comparison, etc.). The server platform may then retrieve the content that has the highest similarity to the user request embeddings, as this content is most likely to be relevant to the user's request.

The server platform may retrieve various content from the database depending on the context. For example, if a teacher asks about a student's performance, the pertinent data retrieved by the server platform may include the student's scores or other related student data. In these examples, some aspect of the user's input, such as an object they specified, may be used by the server platform to perform embedding matching to locate the relevant data from the database. The workflow may specify which type or which terms or objects from the user request are used to find and retrieve the relevant data.

This vector comparison method is powerful and flexible, as it can work with any type of data that can be vectorized, from course materials in the case of a student learning request, to student performance data in the case of a teacher inquiry. In each case, the workflow indicates which terms or objects from the user request should be used by the server platform to identify and retrieve the most relevant data from the database.

At step 308, once the relevant data is retrieved from the database, the server platform may generate a prompt for the language model. This prompt may incorporate a portion or the entirety of the data retrieved from the database. The prompt may also include any standard prompting language specified by the workflow. For instance, when the workflow involves instructing a user about specific material, the prompt may incorporate default language that asks the language model to assist the user in understanding the material. Additionally or alternatively, the user request received at step 301 may be incorporated into the language model prompt.

In some cases, the server platform may tokenize and/or generate embeddings of the complete language model prompt as part of step 308 to allow the prompt to be directly input to a language model. For example, some language models may necessitate that inputs are in a tokenized and/or embedded form. Alternatively, some language models may be equipped with libraries that include a tokenizer and/or embeddings model. For instance, an API for a language model may accept a plain text prompt and handle tokenization and/or embeddings of the inputs to the language model.

As a detailed example, a user request may be “Please explain the Pythagorean theorem to me.” The server platform may find a matching workflow for explaining content to a student, which may indicate that relevant data specified in the request should be retrieved and provided as part of a language model prompt. The server platform 110 may then use the embeddings corresponding to the object of the request to find and retrieve vectorized content related to the Pythagorean theorem from the database. The prompt generated for the language model may further include the user's request, the relevant data retrieved, and default language associated with the workflow, such as “Help the user understand the above material.” The complete prompt, as specified by the workflow may read: “‘Please explain the Pythagorean theorem to me.’ Relevant data: [insert vectorized content related to the Pythagorean theorem]. Help the user understand the above material” The entire prompt may be tokenized as an input to the language model.

At step 309, the server platform 110 may use the language model in an inference mode with the generated prompt as an input. Thus, the server platform may run inference by providing the tokenized prompt to the input layer of the language model. Alternatively, the server platform may send the prompt, either in its tokenized form or in plain text format, to an Application Programming Interface (API) hosted by a third-party platform that provides a language model service.

At step 310, the server platform 110 may receive the response generated by the language model. This response is the output produced by the language model after processing the tokenized prompt in inference mode. The format in which this response is received may vary. For example, it may be received in a tokenized format or in plain text format. In cases where the response is delivered in a tokenized format, the server platform may convert the response back to plain text format for provision to the user. In some cases, the server platform may perform other processing tasks on the plain text response, such as analyzing it for relevance or accuracy before it is communicated to the user.

At step 311, the server platform may transmit the response that was received from the language model to the user. The response may be displayed or otherwise output via the client device, for example through a browser application or some other client application running on the client device.

In embodiments, the server platform 110 may convert the response into a different format before sending it to the user. For example, when the user is using an audio interface, the server platform may convert the response to speech using the text-to-speech module within the server platform. However, the server platform may also simply transmit a plain text response to the user, such as when the user interface is a text-based interface where the response can be directly displayed as textual content.

In some cases, the server platform may modify the response received from the language model before transmitting it to the user. For example, the server platform may inject specific information into the response. As one example, the server platform may inject questions into the response that solicit personal information from the user. The user may then respond with answers to the personal questions that can subsequently be used by the server platform to customize content delivery to the user.

Other types of information may also be injected into the response, such as requests for reviews or assessments of the responses generated by the language model, requests for more information that is needed to complete a workflow (e.g., a number of questions for an assessment, what type of questions to use for an assessment, etc.), and/or the like. These requests may serve as a mechanism for gathering user feedback about the performance of the language model and/or supplying missing information to workflows. For example, the server platform 110 may use the feedback for fine-tuning the language model, thereby enhancing its overall performance and accuracy, as described below.

In some cases, the server platform may transmit the response alongside a request to approve the content generated by the language model. This request may be injected by the server platform based on the specific workflow. For instance, if a teacher's request was matched to workflow for generating content for an assignment, and the language model generated some content for the assignment, the server platform may embed a request into the response, prompting the teacher to approve the generated content, edit it, or retry the content generation. This feedback therefore gives a teacher/admin the power to control the quality and relevance of the generated content.

In some cases, the server platform may handle a user's response to the injected question or feedback request in a unique manner. For example, if the server platform solicits feedback and the user provides a follow-up response, the server platform may bypass the standard processing procedure for such a response (e.g., the follow-up user input may not be processed as described at steps 301-305). Instead, the server platform 110 may use a specialized feedback parser to process the follow-up response (e.g., the feedback parser may use a reduced subset of embeddings and/or workflows for handling feedback). The feedback parser may be implemented by the command parser and may optimized to recognize whether a user approves or rejects generated content, for example.

At step 312, after transmitting the response to the user, the server platform may store or otherwise log the request and response, for example as chat history data. This data may include the user request that was initially received (at step 301), any response generated by the language model and potentially modified by the server platform, and/or any user feedback on the response. The logged data may be stored to maintain a comprehensive chat history.

The chat history may be maintained in one of several formats. For example, the server platform may store the chat history in a tokenized format. This format can be particularly useful for maintaining a conversation history, which can be resubmitted to the language model as context in future prompts to maintain an ongoing conversation. Additionally, the server platform may store a raw conversation history, which may be useful for fine-tuning.

Additionally or alternatively, at 312 the server platform 110 may store/log any data input via direct input, which may include any of the data stored with the database, such as course data, user data, organization data, workflow, data, chat history data, and/or third-party data, and/or edits thereto.

In some cases, depending on the data stored and/or logged at step 312, the server platform 110 may transmit a notification (not explicitly shown in FIG. 3) to a user. Notifications settings may be specified via the workflows 241 and/or as preferences within teacher/admin data 231, user data 220, etc. For example, when a teacher/admin generates and causes storage of a new assignment or assessment, a student or other user may be notified that the new assignment/assessment is available. Similarly, when a student/user completes an assignment/assessment by causing storage of the completed assignment 222 or assessment 223 (e.g., including the student/user answers to the assignment or assessment tasks/questions), the teacher/admin may be notified that the student/user has completed the assignment or assessment. Then, after a teacher/admin scores or grades an assignment or assessment, the student/user may be notified that the score/grade is available. Other example notifications may be specified by various workflows 241. The platform 110 may transmit the notifications in different ways, such as text messages, emails, and/or the like. Additionally or alternatively, the platform 110 may transmit a notification as a message in a conversation history. In some embodiments, the platform 110 may insert a notification into a conversation history if the user is currently engaging with the system via an active session, and otherwise may send the notification via some other route (e.g., text message).

Following step 312, the user may continue to interact with the language model by submitting additional requests. After an additional request is received, the flow may loop back to step 301 as illustrated. These additional requests may (in some cases) trigger further workflows, which may necessitate additional prompts to the language model and/or direct inputs.

In some cases, as shown in step 313, there may be no matching workflows for a user request. In such instances, the server platform 110 may transmit the user request directly to the language model, allowing the language model to respond appropriately based on the conversation history. Additionally or alternatively, the server platform 110 may retrieve relevant course material or other data from the database based on matching the request to metadata (e.g., category and/or sub-category metadata, which may be added upon ingestion as described above). In other words, when there is no matching workflow, a “default workflow” may be used to find whatever data is most relevant to the query based on metadata associated with the data.

It should be noted that because the method of FIG. 3 loops, user requests may trigger different workflows (or no workflow) for each different request (where each request may correspond to a different pass through the loop). Thus, for example, users may ask an initial question that triggers a workflow, then ask follow-up questions and/or for more detailed explanations of certain content without necessarily triggering additional workflows, depending on the text of the user request and the results of steps 304 and 305. This interaction process enables the user to continue asking questions based on the context of the conversation history. For example, the user may ask follow-up questions about material that they are learning, seeking clarification from the language model based on the context provided by the conversation history.

The server platform may store and maintain conversation histories in various formats and contexts. In some embodiments, each user may be associated with a different conversation history that is specific to a given course. Additionally or alternatively, users may maintain multiple conversation histories for different topics. For example, a user might have a first conversation history associated with a first subject they are learning, a second conversation history related to an assignment they are completing, and a third conversation history linked with an assessment they need to complete. Each conversation history may be initiated by the user or automatically started by the server platform based on a context shift or based on the triggering of a certain workflow.

At step 314, as previously mentioned, some workflows may specify a direct input. If the server platform has selected a matching workflow that is associated with a direct input method, the server platform may retrieve a form that is linked with the matching workflow. The form may be stored in conjunction with the workflow within the database. The form may specify a variety of input items intended for the user. The nature of these input items may vary, incorporating aspects such as text boxes, drop-down menus, and similar interactive elements. Furthermore, the form might outline default sets of alternatives for the drop-down menus or selectable items. In some embodiments, the workflow may indicate that the server platform should issue a request to a language model to obtain alternatives to populate the drop-down menus or other elements, and the server platform may do so. The form may serve to generate an interactive user interface that may allow the user to complete the form.

In some cases, a workflow may be associated with multiple forms, which the server platform may select among depending on context. For example, a workflow may be designed for generating an assessment. In this case, the user request may have dictated the number and/or type of questions to be included in the assessment (e.g., multiple choice, essay, etc.). Consequently, the server platform may select a form based on the specified number and type of questions. Accordingly, the server platform may select a form based on the user request.

In some cases, the form may be too complex for certain user interfaces, such as mobile application user interfaces or audio interfaces. The server platform may decide to redirect the user to a different platform at step 315 depending on the complexity of the form (e.g., number of questions, types of interface elements, number of options, input methods available), etc. In these cases, the server platform may redirect the user to a different interface at step 316, such as a web browser interface that may be accessed via a general-purpose computing device.

At step 317, the server platform may transmit an interactive user interface that enables the user to complete the form. The interactive user interface may encompass a variety of input elements such as drop-down menus and text boxes, amongst others. These input elements are designed to allow the user to input the necessary data to complete the form. For example, the user can interact with the input elements to provide specified data. At step 318, the server platform receives the user inputs and stores them as specified by the form. In some cases, the interactive user interface and/or the server platform may be configured to conduct certain checks on the user's input, such as sanity checking, type checking, or other input verification methods.

At step 312, the server platform may store the user inputs as part of a chat history, as shown in the attached figure. The server platform may also store the user input data as part of the workflow data, student data, organization data, course data, or any other data maintained by the database. The form may indicate where and how to store the data in the database.

For example, the server platform may employ various workflows designed to configure the organization data, student data, course data, and more. The workflows may allow different users, such as teachers, administrators, or students, to directly input specific types of data. For instance, teachers or administrators may input workflow data, organization data, or course data, while students may enter data pertaining to their personal details, answers to questions, assignment results, and other related information.

At step 319, the server platform 110 may occasionally fine-tune the language model using various data that has been stored within the database. The fine-tuning process may be initiated by the server platform when it determines that sufficient data, based on user interactions, has been accumulated and logged. For example, the server platform may store a threshold for data accumulation that may specify a number of words, tokens, bytes, and/or other relevant metrics. Once this threshold is reached, the server platform may proceed to fine-tune the language model using the accumulated data.

In some cases, the server platform may proceed to fine-tune the language model based on the availability of a certain number of examples of requests and responses, which may serve as training data for the language model. This fine-tuning process is designed to enhance the accuracy and efficacy of the model in generating responses.

The fine-tuning process of the language model may also be influenced by various types of data. One such data type may include chat history data, where the server platform may use user feedback to ascertain the quality of language model-generated responses and only fine-tune the language model with the responses that are judged to be high quality. Additionally or alternatively, the server platform 110 may use the evaluations of response quality to fine-tune the language model. Moreover, the server platform may also infer response quality from certain context indicators, such as follow-up responses from the user.

In some cases, the server platform 110 may fine-tune the language model using other forms of data such as course material data, curriculum data, student performance data, personal data, teacher data, course data, and any other data that is stored or maintained by the database. The process of fine-tuning the language model may require the data to be provided in a specific format. For example, the server platform may tokenize and/or vectorize the data prior to fine-tuning.

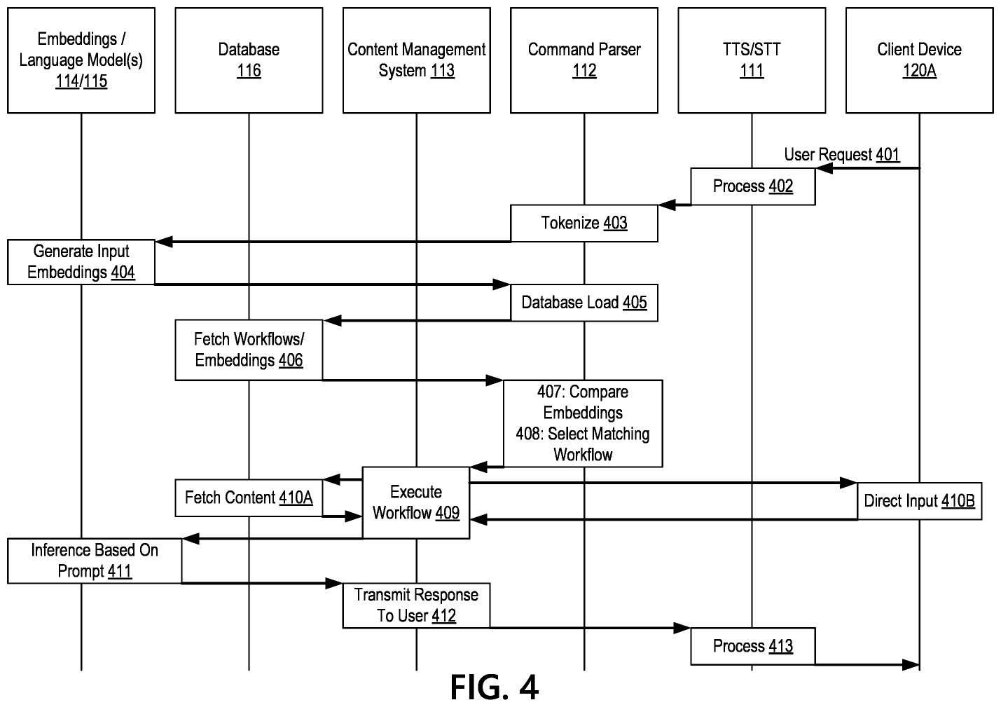

FIG. 4 is another diagram illustrating an example flow involving components of the server platform 110 and an example client device 120A. Again, the flow of FIG. 4 is not intended to be a comprehensive diagram illustrating each and every function of the various components, but instead illustrates example operations that may be performed in at least some cases to explain the functionality of the system.

At 401, the client device 120A (e.g., a device used by a teacher, student, administrator, or other user), may send a user request to the server platform 110. In the illustrated example, the request may include audio data, which may be routed to the TTS/STT module 111 by the server platform 110. The TTS/STT module 111 may process the request at 402 to generate text from the audio data. At 403, the command parser 112 may tokenize the textual user request, as described above for step 302. Then, at 404, the server platform 110 may use an embeddings model 114 to generate input embeddings of the tokenized user request, as described above for step 303. Next, at steps 405 and 406, the command parser 112 may load various workflows and prestored embeddings (if not previously loaded into memory) from the database 116. Then, at steps 407 and 408, the command parser 112 may compare the input embeddings to the prestored embeddings to find a matching workflow, as described for steps 304 and 305. In embodiments, the command parser may use a single pass or multiple passes through prestored action and/or object embeddings, as described above. The illustrated flow presumes that a matching workflow is found and selected, although in some cases there may be no matching workflow, as described above for step 313.

At step 409, the content management system 113 may execute the selected workflow, which may involve fetching relevant content 410A from the database 116 as described above for step 307 and/or obtaining direct input 410B from the user as described above for steps 314-318. The server platform 110 may then generate a prompt and run inference using the language model with the generated prompt as input at 411, as described above for steps 308-310. At 412, the content management system may transmit the response to the user, which may include preprocessing steps such as question injection and/or feedback solicitation, as described above for step 311. At 413, the TTS/STT module 111 may convert the textual response to audio for output at the client device (e.g., assuming the user is using an audio interface; alternately, a text response may be transmitted directly to the client device 120A) and transmit the response to the client device 120A. As described above for FIG. 3, the process of FIG. 4 may repeatedly execute as additional user requests 401 are received and processed. Each request may correspond to a workflow or no workflow, and the system may handle each response differently depending on the matching workflow (or lack thereof) as described herein generally. Thus, a user may continue to interact with the system to make various requests, perform various actions, interact with a language model to ask follow-up questions or clarifications, and otherwise engage with the system in various roles such as admin, teacher, student, user, etc.

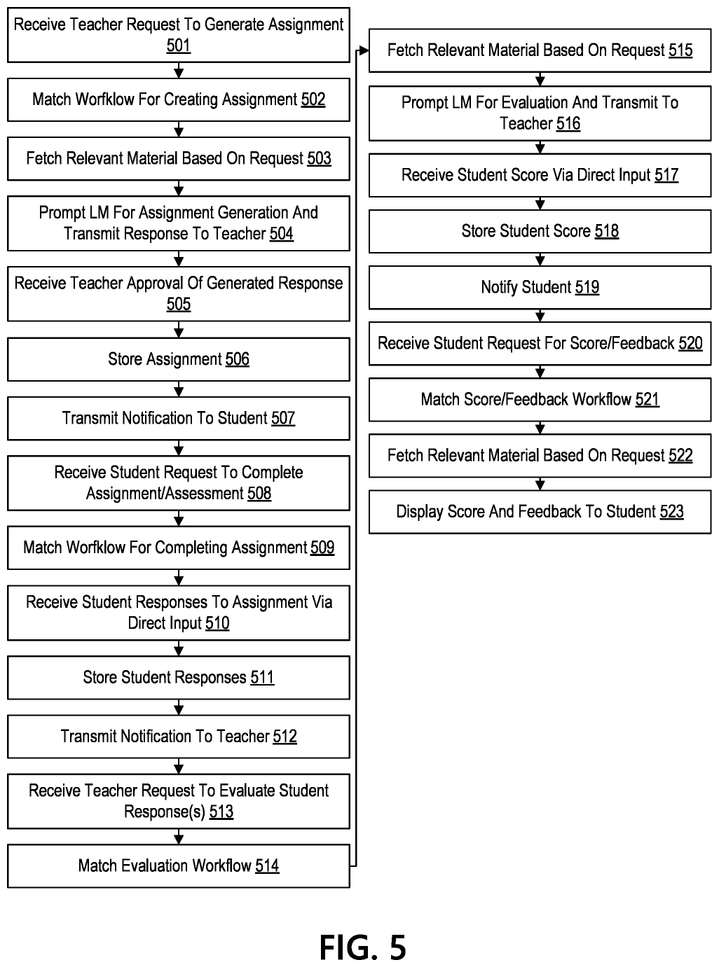

FIG. 5 illustrates an example flow that more explicitly shows example repeated interactions involving multiple users engaging with the system to accomplishing respective tasks (here, a teacher setting up an assignment, a student completing the assignment, a teacher grading the assignment, and a student viewing feedback on the assignment). Although the illustrated example is specific to a teacher-student interaction, it should be understood that other examples in similar contexts are within the scope of the disclosure. For example, the method of FIG. 5 could be used in a healthcare setting to create an assessment for lab technicians (who would take the role of students) managed by a manager (who would take the role of teacher). Other similar examples will be apparent to a person of ordinary skill in the art.

At 501, a teacher may transmit a request that indicates the teacher wishes to generate an assignment. At 502, the platform 110 may match the request to a workflow 241 for creating an assignment. Step 502 may involve tokenizing the teacher request, generating embeddings, comparing the input embeddings to prestored embeddings, leveraging a decision tree, and other such steps as described elsewhere herein. Because these and other such steps are described in detail elsewhere, they may be assumed for FIG. 5 for the sake of simplicity and brevity.

At 503, the platform 110 may fetch relevant material from the database for generating the assignment. For example, if the teacher specified which material the assignment should be about, the platform 110 may fetch the specified subject matter 212. Additionally or alternatively, the platform 110 may infer which content to retrieve based on various contextual data (e.g., if the teacher previously generated an assignment for chapter 1 of a textbook that is stored in the subject matter 212, then the platform 110 may assume this assignment is for chapter 2 of the textbook, or whatever chapter is indicated to be next in curriculum data 211). The platform 110 may retrieve course materials, past assignments, assignments generated by other teachers, third party materials, or any other relevant data as indicated by the matching workflow, various contextual data, and/or the teacher request.

At 504, the platform 110 may generate a prompt (including any or all of the relevant materials, the teacher request, a prompt template 244, etc.) and run inference using the language model 115, then transmit the generated response to the teacher. Additionally or alternatively (not shown), the workflow for generating an assignment may involve direct input (e.g., so the teacher can directly input assignment materials). At 505, the teacher may approve the generated response. Although not shown in this example flow, the teacher may also reject or edit the response generated by the LLM before providing approval. Although again not shown, in some cases the teacher may proceed with several requests and responses to generate a full assignment. For example, the assignment generation workflow may only generate a single question at a time, and the teacher may accordingly run the workflow several times to generate a full assignment, which may include various tasks and/or questions of various types (e.g., essay questions/assignments, multiple choice, etc.).

At 506, the platform 110 may store the approved assignment after approval from the teacher. At 507, it may transfer a notification to a device associated with a student that is enrolled in the course for which the assignment was generated (as well as all of the other students enrolled in the course).

At 508, the platform 110 may receive a request from the student device that indicate the student wants to complete the assignment. At step 509, the platform 110 may match the request to a workflow for completing the assignment. (As above, tokenization, embedding, and workflow matching steps are described in detail elsewhere for the sake of brevity here). In the example flow, the assignment completion workflow may involve direct input of the student's answers to the questions of the assignment, which the platform 110 may provide using a form 242 presented via an interactive user interface. Additionally or alternatively, although not shown, the assignment completion workflow may allow the student to ask the language model for explanations of certain topics that are relevant to the assignment.

At 510, the platform 110 may receive the student responses, which may be stored at 511. At 512, the platform 110 may transmit a notification to the client device associated with the teacher indicating that the student completed the assignment. Additionally or alternatively, the teacher may only receive a notification when all students complete an assignment, when one or more students are late in completing an assignment, have not completed an assignment, etc. In embodiments, the teacher may configure these and other notifications as desired.

At 513, the platform 110 may receive a teacher request to evaluate the student's responses to the assignment. At 514, the platform 110 may match the request to a workflow for evaluating the student's responses. At 515, the platform may fetch relevant material for evaluating the student's responses, which may include any or all of the materials obtained at step 503, answer keys, evaluation/scoring guides generated by the teacher or organization, etc. At 516, the platform 110 may generate a prompt and run inference using the language model to generate the evaluation, which the platform 110 may transmit to the teacher. For example, the generated prompt may request the language model to analyze the student's responses, attempt to determine any concepts the student may not yet have mastered, provide proposed explanations that may assist the student in mastering the concepts, etc.

At 517, the teacher may use direct input to provide a student score. In some cases (e.g., if the evaluation workflow is so configured), the teacher may view the LM-generated evaluation to assist in generating the student score. Additionally or alternatively, the teacher may edit the LM-generated evaluation (e.g., to improve the evaluation, correct the evaluation, etc.) and/or provide the teacher's own evaluation. At 518, the platform 110 may store the score assigned by the teacher (and/or any edits to the LM-generated evaluation or teacher evaluation). At 519, the platform 110 may notify the device associated with the student that a score and/or evaluation is available.

At 520, the platform 110 may receive a student request for the score and/or feedback on the assignment. At 521, the platform 110 may match the student request to a score/feedback workflow. At 522, the platform 110 may fetch relevant material for the score/feedback workflow (e.g., the student's score and/or evaluation, any or all of the course material used at 502, etc.). At 523, the platform 110 may display the score and feedback to the student 523. Then, because the relevant material has been loaded into the context of the conversation history, the student may continue the conversation by asking follow-up questions, asking for additional assistance in learning the material, etc. In other words, the student may continually engage with the system and continue with the conversation history as necessary and desired to learn the material.

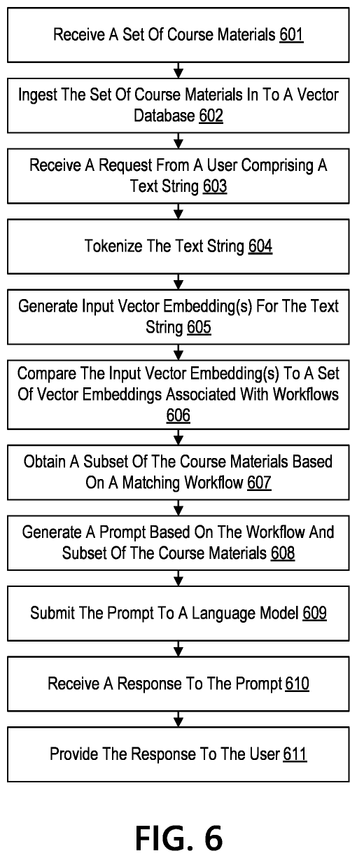

FIG. 6 shows an example method of processing requests related to course materials for an educational course that may be executed by the platform 110. The method comprises receiving, by the server platform, a set of course materials. The method further comprises ingesting, by the server platform, the set of course materials into a vector database. The method further comprises receiving, by the server platform, a request comprising a string of text from a user, wherein the user is associated with a role indicating the user is an instructor or a student. The method further comprises tokenizing, by the server platform, the string of text using a tokenizer. The method further comprises generating, by the server platform, one or more input vector embeddings for the tokenized string of text using an embeddings model. The method further comprises comparing, by the server platform, the one or more input vector embeddings to at least one set of vector embeddings associated with workflows to find a matching workflow. The method further comprises obtaining, by the server platform, a subset of the course materials corresponding to the matching workflow from the vector database. The method further comprises generating, by the server platform, a prompt based on the workflow and the subset of course materials. The method further comprises submitting, by the server platform, the prompt to a language model. The method further comprises receiving, by the server platform, a response to the prompt from the language model. The method further comprises providing, by the server platform, the response to a user device of the user.

### Conclusion

While only a few embodiments of the present disclosure have been shown and described, it will be obvious to those skilled in the art that many changes and modifications may be made thereunto without departing from the spirit and scope of the present disclosure as described in the following claims. All patent applications and patents, both foreign and domestic, and all other publications referenced herein are incorporated herein in their entireties to the full extent permitted by law.

The methods and systems described herein may be deployed in part or in whole through a machine that executes computer software, program codes, and/or instructions on a processor. The present disclosure may be implemented as a method on the machine, as a system or apparatus as part of or in relation to the machine, or as a computer program product embodied in a computer readable medium executing on one or more of the machines. In embodiments, the processor may be part of a server, cloud server, client, network infrastructure, mobile computing platform, stationary computing platform, or other computing platforms. A processor may be any kind of computational or processing device capable of executing program instructions, codes, binary instructions and the like, including a central processing unit (CPU), a general processing unit (GPU), a logic board, a chip (e.g., a graphics chip, a video processing chip, a data compression chip, or the like), a chipset, a controller, a system-on-chip (e.g., an RF system on chip, an AI system on chip, a video processing system on chip, or others), an integrated circuit, an application specific integrated circuit (ASIC), a field programmable gate array (FPGA), an approximate computing processor, a quantum computing processor, a parallel computing processor, a neural network processor, or other type of processor. The processor may be or may include a signal processor, digital processor, data processor, embedded processor, microprocessor or any variant such as a co-processor (math co-processor, graphic co-processor, communication co-processor, video co-processor, AI co-processor, and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor, or any machine utilizing one, may include non-transitory memory that stores methods, codes, instructions and programs as described herein and elsewhere. The processor may access a non-transitory storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache, network-attached storage, server-based storage, and the like.

A processor may include one or more cores that may enhance speed and performance of a multiprocessor. In embodiments, the process may be a dual core processor, quad core processors, other chip-level multiprocessor and the like that combine two or more independent cores (sometimes called a die).

The methods and systems described herein may be deployed in part or in whole through a machine that executes computer software on a server, client, firewall, gateway, hub, router, switch, infrastructure-as-a-service, platform-as-a-service, or other such computer and/or networking hardware or system. The software may be associated with a server that may include a file server, print server, domain server, internet server, intranet server, cloud server, infrastructure-as-a-service server, platform-as-a-service server, web server, and other variants such as secondary server, host server, distributed server, failover server, backup server, server farm, and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for the execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements. The methods and systems described herein may be adapted for use with any kind of private, community, or hybrid cloud computing network or cloud computing environment, including those which involve features of software as a service (SaaS), platform as a service (PaaS), and/or infrastructure as a service (IaaS).

The methods, program codes, and instructions described herein and elsewhere may be implemented on a cellular network with multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, 4G, 5G, LTE, EVDO, mesh, or other network types.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic book readers, music players and the like. These devices may include, apart from other components, a storage medium such as flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, network-attached storage, network storage, NVME-accessible storage, PCIE connected storage, distributed storage, and the like.

The methods and systems described herein may transform physical and/or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable code using a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices, artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions. Computer software may employ virtualization, virtual machines, containers, dock facilities, portainers, and other capabilities.

Thus, in one aspect, methods described above and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “with,” “including,” and “containing” are to be construed as open-ended terms (i.e., meaning “including, but not limited to,”) unless otherwise noted. Recitations of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. The term “set” may include a set with a single member. No language in the specification should be construed as indicating any non-claimed element as essential to the practice of the disclosure.

While the foregoing written description enables one skilled to make and use what is considered presently to be the best mode thereof, those skilled in the art will understand and appreciate the existence of variations, combinations, and equivalents of the specific embodiment, method, and examples herein. The disclosure should therefore not be limited by the above-described embodiment, method, and examples, but by all embodiments and methods within the scope and spirit of the disclosure.

All documents referenced herein are hereby incorporated by reference as if fully set forth herein.

1. A method of processing requests related to course materials for an educational course, the method comprising:
receiving, by a server platform, a set of course materials;
ingesting, by the server platform, the set of course materials into a vector database;
receiving, by the server platform, a request comprising a string of text from a user, wherein the user is associated with a role indicating the user is an administrator or an end user;
tokenizing, by the server platform, the string of text using a tokenizer;
generating, by the server platform, one or more input vector embeddings for the tokenized string of text using an embeddings model;
comparing, by the server platform, the one or more input vector embeddings to at least one set of vector embeddings associated with workflows to find a matching workflow;
obtaining, by the server platform, a subset of the course materials corresponding to the matching workflow from the vector database;
generating, by the server platform, a prompt based on the workflow and the subset of course materials;
submitting, by the server platform, the prompt to a language model;
receiving, by the server platform, a response to the prompt from the language model; and
providing, by the server platform, the response to a user device of the user.

2. The method of claim 1, wherein the comparing comprises:
comparing the one or more input vector embeddings to a first set of vector embeddings to recognize an action associated with the string of text;
comparing the one or more input vector embeddings to a second set of vector embeddings to recognize at least one object associated with the string of text; and
selecting the matching workflow based on the recognized action and the at least one recognized object.

3. The method of claim 2, wherein comparing the one or more input vector embeddings to the second set of vector embeddings comprises multiple comparison passes to recognize multiple objects associated with the string of text.

4. The method of claim 1, wherein the string of text from the user is generated using a speech to text algorithm that processes audio data from the user.

5. The method of claim 1, wherein the workflow is associated with a form, further comprising:
generating, by the server platform, an interactive user interface for completing the form;
transmitting, by the server platform, the interactive user interface to the user;
receiving, by the server platform, a completed form from the user; and
storing, by the server platform, the completed form in the vector database, wherein data from the completed form may be submitted as part of a future prompt to the language model.

6. The method of claim 5, wherein the interactive user interface is generated for a web interface, further comprising:
determining that the user is using a mobile interface on the user device; and
redirecting the user to the web interface.

7. The method of claim 1, wherein providing the response to the user comprises:
converting the response to audio using a speech to text model; and
transmitting the audio to the user device.

8. The method of claim 1, wherein the request and the response are a first request and a first response, the method further comprising:
receiving a second request comprising a second string of text from the user;
tokenizing the second string of text using the tokenizer;
generating one or more second input vector embeddings for the tokenized second string of text using the embeddings model;
comparing the one or more second input vector embeddings to the at least one set of vector embeddings associated with workflows;
determining that none of the workflows match the one or more second input vector embeddings; and
responsive to the determining, submitting the one or more second input vector embeddings as a second prompt to the language model;
receiving a second response to the second prompt from the language model; and
providing the second response to the user device of the user for display together with the first request, first response, second request, and second response.

9. The method of claim 8, further comprising:
storing the first request, first response, second request, and second response in the vector database; and
fine-tuning the language model using a data set that includes the first request, first response, second request, and second response.

10. The method of claim 9, wherein the data set further includes a plurality of requests and responses that are associated with a particular course for a particular educational institution, such that the fine-tuned language model is customized to the particular course and the particular educational institution.

11. The method of claim 1, wherein the matching workflow comprises one or more of:
a workflow that allows the administrator to generate an assignment based on a subset of the course materials;
a workflow that allows the administrator to generate an assessment based on a subset of the course materials;
a workflow that allows the administrator to interact with a curriculum;
a workflow that allows the administrator to input data about an organization;
a workflow that allows the administrator to input data about one or more end users;
a workflow that allows the end user to ask for assistance with a subset of course materials;
a workflow that allows the end user to complete the assignment; or
a workflow that allows the end user to complete the assessment.

12. The method of claim 1, further comprising:
after providing the response to the user device, requesting feedback from the user on the response; and
based on the feedback, determining whether to update the course materials using the response.

13. The method of claim 12, wherein the matching workflow is a workflow that allows the administrator to generate an assignment, wherein the response comprises the generated assignment, wherein requesting feedback comprises requesting whether the generated assignment should be saved and assigned to end users.

14. The method of claim 13, further comprising, responsive to receiving feedback indicating that the generated assignment should be saved and assigned to end users, transmitting a notification to the end users that the assignment is available.

15. The method of claim 14, further comprising:
determining that at least one of the end users has completed the assignment; and
transmitting a notification to the administrator indicating that at least one of the end users has completed the assignment.

16. The method of claim 1, wherein the comparing comprises generating a similarity score using a dot product operation.

17. The method of claim 1, further comprising:
prior to providing the response to a user device of the user, modifying the response to include a question about the user;
receiving an answer from the user to the question about the user; and
storing the answer from the user in the vector database, wherein the answer from the user may be submitted as part of a future prompt to the language model.

18. The method of claim 1, wherein the course materials include a textbook.

19. A system comprising:
one or more processors; and
memory storing instructions that, when executed by the one or more processors, cause the system perform steps comprising:
receiving a set of course materials;
ingesting the set of course materials into a vector database;
receiving a request comprising a string of text from a user, wherein the user is associated with a role indicating the user is an administrator or an end user;
tokenizing the string of text using a tokenizer;
generating one or more input vector embeddings for the tokenized string of text using an embeddings model;
comparing the one or more input vector embeddings to at least one set of vector embeddings associated with workflows to find a matching workflow;
obtaining a subset of the course materials corresponding to the matching workflow from the vector database;
generating a prompt based on the workflow and the subset of course materials;
submitting the prompt to a language model;
receiving a response to the prompt from the language model; and
providing the response to a user device of the user.

20. A non-transitory computer-readable medium comprising instructions that, when executed by one or more processors, cause the processors to perform steps comprising:
receiving a set of course materials;
ingesting the set of course materials into a vector database;
receiving a request comprising a string of text from a user, wherein the user is associated with a role indicating the user is an administrator or an end user;
tokenizing the string of text using a tokenizer;
generating one or more input vector embeddings for the tokenized string of text using an embeddings model;
comparing the one or more input vector embeddings to at least one set of vector embeddings associated with workflows to find a matching workflow;
obtaining a subset of the course materials corresponding to the matching workflow from the vector database;
generating a prompt based on the workflow and the subset of course materials;
submitting the prompt to a language model;
receiving a response to the prompt from the language model; and
providing the response to a user device of the user.
